(19) United States
(12) Patent Application Publication
(10) Pub. No.: US 2020/0034722 A1
(43) Pub. Date: Jan. 30, 2020

(54) NON-FACTOID QUESTION-ANSWERING SYSTEM AND METHOD AND COMPUTER PROGRAM THEREFOR

(71) Applicant: National Institute of Information and Communications Technology, Tokyo (JP)

(72) Inventors: Jonghoon OH, Tokyo (JP); Kentaro TORISAWA, Tokyo (JP); Canasai KRUENGKRAI, Tokyo (JP); Ryu IIDA, Tokyo (JP); Julien KLOETZER, Tokyo (JP)

(21) Appl. No.: 16/338,465

(22) PCT Filed: Oct. 2, 2017
(86) PCT No.: PCT/JP2017/035765

§ 371 Date: Mar. 30, 2019

(30) Foreign Application Priority Data
Oct. 7, 2016 (JP) 2016-198929
Jul. 4, 2017 (JP) 2017-131291

(51) Int. Cl. G06N 5/04; G09B 7/00; G06F 17/27; G06F 16/332; G06F 16/33

(52) U.S. Cl. CPC G06N 5/04; G09B 7/00; G06F 16/3326; G06F 16/3329; G06F 16/3334; G06F 17/2785

(57) ABSTRACT

A question-answering system includes a storage unit storing expressions representing causality; an answer receiving unit receiving a question and answer passages each including an answer candidate to the question; a causality expression extracting unit extracting a causality expression from each of the answer passages; a relevant causality expression extracting unit selecting, for a combination of the question and an answer passage, an expression most relevant to the combination, from the storage unit; and a neural network receiving the question, the answer passages, semantic relation expressions related to the answer passages, and one of the relevant expressions for the combination of the question and the answer passages, and selecting an answer to the question from the answer passages.

### TECHNICAL FIELD

The present invention relates to a question-answering system and, more specifically, to an improvement of a question-answering system for a non-factoid question related to reason, method, definition or the like, rather than a factoid question that can be answered by a simple word or words.

### BACKGROUND ART

Causality is the essential part of the semantic knowledge for why-question answering tasks. A why-question answering task is a task to retrieve answers to why-questions such as “why are tsunamis generated?” from a text archive containing a large number of texts. Non-Patent Literature 1 discloses a prior art technique for this purpose. According to Non-Patent Literature 1, causality in answer passages are recognized by using a clue terms such as “because” or causality patterns such as “A causes B,” and the recognized causality is used as a clue for answer selection or answer ranking. Examples of such processing include correct/error classification of answer passages and ranking of answer passages in accordance with the degree of correctness.

### CITATION LIST

### Non Patent Literature

NPL 1: J.-H. Oh, K. Torisawa, C. Hashimoto, M. Sano, S. De Saeger, and K. Ohtake. Why-question answering using intra- and inter-sentential causal relations. In Proceedings of the 51st Annual Meeting of the Association for Computational Linguistics (ACL 2013), pp. 1733-1743, Sofia, Bulgaria, August, 2013.

### SUMMARY OF INVENTION

### Technical Problem

The prior art technique depending on an explicit clue or pattern has a problem that the causalities in an answer passage may be expressed not explicitly but implicitly (without any clue) and, in such a case, the technique will probably fail to accurately identify the causality. By way of example, assume the following question and answer.

TABLE 1

| | |
|---|---|
| Question | Why was the tsunami in the East Japan Earthquake in 2011 |
| | so huge? |
| Answer 1 | In the 2011 East Japan Earthquake, the crustal deformation |
| | was exceptionally large at the bottom of the sea. A large |
| | volume of sea water above the area deformed by the |
| | earthquake was dramatically displaced and a huge tsunami |
| | was generated (CE1). |

Note that the underlined portion CE1 expresses causality without any explicit clue. Because the expression such as CE1 has no clue words, it is difficult for the conventional art to recognize the causality, and it will probably fail to find an answer such as Answer 1 to the question above.

While causality is the most important semantic knowledge for why-question answering tasks as described above, questions are not limited to those of which answers can be inferred only from the causality-related semantic knowledge, and there are questions related to other semantic knowledge. Therefore, a question-answering system that can find answers with a high accuracy to general non-factoid questions is desirable.

Therefore, an object of the present invention is to provide a non-factoid question-answering system capable of giving an accurate answer to a non-factoid question by utilizing the answer patterns including semantic relation expressions related to causality and the like without any explicit cue, as well as to provide a computer program therefor.

### Solution to Problem

According to a first aspect, the present invention provides a non-factoid question-answering system generating an answer to a non-factoid question by focusing on an expression representing a first semantic relation appearing in text. The non-factoid question-answering system includes: a first expression storage means for storing a plurality of expressions representing the first semantic relation; a question/answer receiving means for receiving a question and a plurality of answer passages each including an answer candidate to the question; a first expression extracting means for extracting a semantic relation expression representing the first semantic relation from each of the plurality of answer passages; a relevant expression selecting means for selecting, for each of the combinations of the question and the plurality of answer passages, a relevant expression that is an expression most relevant to the combination, from the plurality of expressions stored in the first expression storage means; and an answer selecting means trained in advance by machine learning to receive, as inputs, each combination of the question, the plurality of answer passages, the semantic relation expressions for the answer passages, and one of the relevant expressions for a combination of the question and the answer passages, and to select an answer to the question from the plurality of answer passages.

Preferably, the non-factoid question-answering system further includes a first semantic correlation calculating means for calculating, for each combination of the question and the plurality of answer passages, a first semantic correlation between each of the words appearing in the question and each of the words appearing in the answer passage in the plurality of expressions stored in the first expression storage means. The answer selecting means includes: an evaluating means trained in advance by machine learning to receive, as inputs, a combination of the question, the plurality of answer passages, the semantic relation expressions for the answer passages, and the relevant expressions for a combination of the question and the answer passages, and to calculate and output an evaluation value representing a measure that the answer passage is an answer to the question, using the first semantic correlation as a weight to each word in the inputs; and a selecting means for selecting one of the plurality of answer passages as an answer to the question, using the evaluation value output by the evaluating means for each of the plurality of answer passages.

More preferably, the non-factoid question-answering system further includes a first semantic relation expression extracting means for extracting an expression representing the first semantic relation from a document archive and for storing it in the first expression storage means.

More preferably, the first semantic correlation calculating means includes: a first semantic correlation storage means for calculating and storing the first semantic correlation of a word pair included in a plurality of expressions representing the first semantic relation stored in the first expression storage means, for each word pair; a first matrix generating means for reading, for each combination of the question and the plurality of answer passages, the first semantic correlation of each pair of words in the question and a word in the answer passage, from the first semantic correlation storage means, for generating a first matrix having words in the question arranged along one axis and words in the answer passage arranged along the other axis, and having, arranged in each cell at an intersection of the one and the other axes, the first semantic correlation between words at corresponding positions; and a second matrix generating means for generating two second matrixes, comprised of a first word-sentence matrix storing, for each of the words arranged along the one axis of the first matrix, the maximum value of the first semantic correlations arranged along the other axis, and a second word-sentence matrix storing, for each of the words arranged along the other axis of the first matrix, the maximum value of the first semantic correlations arranged along the one axis. The non-factoid question-answering system further includes a means for adding a weight to each of the words appearing in the question applied to the answer selecting means using the first semantic correlation of the first word-sentence matrix, and for adding a weight to each of the words appearing in the answer passage using the first semantic correlation of the second word-sentence matrix.

Preferably, each of the first semantic correlations stored in the two second matrixes is normalized in a prescribed range.

More preferably, the first semantic relation is causality.

More preferably, each of the expressions representing the causality includes a cause part and an effect part. The relevant expression selecting means includes: a first word extracting means for extracting a noun, a verb and an adjective from the question; a first expression selecting means for selecting, from the expressions stored in the first expression storage means, only a prescribed number of expressions that includes all the nouns extracted by the first word extracting means in the effect part; a second expression selecting means for selecting, from the expressions stored in the first expression storage means, only a prescribed number of expressions that include all the nouns extracted by the first word extracting means and include at least one of the verbs or adjectives extracted by the first word extracting means in the effect part; and a causality expression selecting means for selecting, for each of the plurality of answer passages, from the expressions selected by the first and second expression selecting means, one that has in the effect part a word common to the answer passage and that is determined to have the highest relevance to the answer passage in accordance with a score calculated by the weight to the common word.

Preferably, the non-factoid question-answering system generates an answer to a non-factoid question by focusing on an expression representing the first semantic relation and an expression representing a second semantic relation appearing in text. The non-factoid question-answering system further includes: a second expression storage means for storing a plurality of expressions representing the second semantic relation; and a second semantic correlation calculating means for calculating, for a combination of the question and each of the plurality of answer passages, a second semantic correlation representing correlation between each of the words appearing in the question and each of the words appearing in the answer passage in the plurality of expressions stored in the second expression storage means. The evaluating means includes a neural network trained in advance by machine learning to receive, as inputs, a combination of the question, the plurality of answer passages, the semantic relation expressions for the answer passages extracted by the first expression extracting means, and the relevant expressions for the question and the answer passages, and to calculate and output the evaluation value, using the first semantic correlation and the second semantic correlation as a weight to each word in the inputs.

More preferably, the second semantic relation is a common semantic relation not limited to a specific semantic relation; and the second expression storage means stores expressions collected at random.

According to a second aspect, the present invention provides a computer program causing a computer to function as each of the means of any of the devices described above.

According to a third aspect, the present invention provides a method of answering to a non-factoid question, realized by a computer generating an answer to a non-factoid question by focusing on an expression representing a prescribed first semantic relation appearing in text. The method includes the steps of: the computer connecting to and enabling communication with a first storage device storing a plurality of expressions representing the first semantic relation; the computer receiving, through an input device, a question and a plurality of answer passages including an answer candidate to the question; the computer extracting, from the plurality of answer passages, an expression representing the first semantic relation; the computer selecting, for each combination of the question and the plurality of answer passages, an expression most relevant to the combination, from the plurality of expressions stored in the first expression storage means; and the computer inputting each of combinations of the question, the plurality of answer passages, the plurality of expressions extracted at the step of extracting, and one of the expressions selected at the step of selecting, to an answer selecting means that is trained in advance by machine learning to select an answer to the question from the plurality of answer passages, and obtaining its output, and thereby generating an answer to the question.

Preferably, the method further includes the step of the computer calculating, for each combination of the question and the plurality of answer passages, a first semantic correlation representing correlation between each of the words appearing in the question and each of the words appearing in the answer passage in the plurality of expressions stored in the first expression storage means. The selecting step includes the step of the computer applying each of combinations of the question, the plurality of answer passages, the expression extracted at the step of extracting from the answer passage, and the expression selected at the selecting step for the question and the answer passage, as an input to an evaluating means trained in advance by machine learning to calculate and output an evaluation value representing a measure that the answer passage is an answer to the question. The evaluating means uses the first semantic correlation as a weight to each word in the input in calculating the evaluation value. The method further includes the step of the computer selecting one of the plurality of answer passages as an answer to the question, using the evaluation value output by the evaluating means to each of the plurality of answer passages.

According to a fourth aspect, the present invention provides a non-factoid question-answering system including: a question/answer receiving means receiving a question sentence and a plurality of answer passages to the question sentence; a causality expression extracting means for extracting a plurality of in-passage causality expressions from the plurality of answer passages; and an archive causality expression storage means for storing a plurality of archive causality expressions extracted from a document archive containing a large amount of documents. Each of the in-passage causality expressions and the archive causality expressions includes a cause part and an effect part. The non-factoid question-answering system further includes: a ranking means for ranking the plurality of archive causality expressions stored in the archive causality expression storage means based on a degree of relevance to each answer passage, and for selecting, for each combination of the question and the answer passage, a top-ranked archive causality expression; and a classifier trained in advance by machine learning to receive the question, the plurality of answer passages, the plurality of in-passage causality expressions and the archive causality expression selected by the ranking means, and to select, as an answer to the question, one of the plurality of answer passages.

Preferably, the non-factoid question-answering system further includes: a correlation storage means for storing correlation as a measure representing correlation between each of the word pairs used in each answer passage; and a weight adding means for reading, for each combination of the question and each of the answer passages, a correlation of each combination of a word extracted from the question and a word extracted from the answer passage, from the correlation storage means, and for adding a weight in accordance with the correlation, to each word of the answer passage and the question applied to the classifying means.

More preferably, the weight adding means includes: a first matrix generating means for reading, for each combination of the question and the plurality of answer passages, the correlation of each combination of words extracted from the question and words extracted from the answer passage, from the correlation storage means, for generating a first matrix having words extracted from the question arranged along one axis and words extracted from the answer passage arranged along the other axis, and having, at an intersection of said one and the other axes, the correlation between words at corresponding positions of respective axes; a second matrix generating means for generating two second matrixes, comprised of a first word-sentence matrix storing, for each of the words arranged along the one axis of the first matrix, the maximum value of the correlations arranged along the other axis, and a second word-sentence matrix storing, for each of the words arranged along the other axis of the first matrix, the maximum value of the correlations arranged along the one axis; and a means for adding a weight based on causality attention, to each of word vectors representing a question applied to the classifying means, using the first matrix and the first word-sentence matrix, and to each of the word vectors representing an answer passage, using the first matrix and the second word-sentence matrix.

More preferably, the correlations stored in the first matrix and the two second matrixes are normalized between 0 and 1.

The ranking means may include: a first word extracting means for extracting a noun, a verb and an adjective from a question; a first archive causality expression selecting means for selecting, from the archive causality expressions, only a prescribed number of expressions that includes all the nouns extracted by the first word extracting means; a second archive causality expression selecting means for selecting, from the archive causality expressions, only a prescribed number of expressions that include all the nouns extracted by the first word extracting means and include at least one of the verbs or adjectives extracted by the first word extracting means; and a relevant causality expression selecting means for selecting, for each answer passage, from the archive causality expressions selected by the first and second archive causality expression selecting means, one that has in the effect part a word common to the answer passage and that is determined to have the highest relevance to the answer passage in accordance with a score calculated by the weight to the common word.

### BRIEF DESCRIPTION OF DRAWINGS

FIG. 1 is a block diagram schematically showing a configuration of a non-factoid question answering system in accordance with a first embodiment of the present invention.

FIG. 2 is a block diagram schematically showing a configuration of a question-related archive causality expression selecting unit shown in FIG. 1.

FIG. 3 is a schematic illustration of a word-to-word mutual information matrix.

FIG. 4 schematically shows a configuration of a multi-column convolutional neural network used in the first embodiment of the present invention.

FIG. 5 is a schematic illustration showing a structure in the convolutional neural network.

FIG. 6 is an illustration of a training process of the non-factoid question-answering system in accordance with the first embodiment of the present invention.

FIG. 7 is a flowchart representing a control structure of a program realizing, by a computer, the non-factoid question-answering system in accordance with the first embodiment of the present invention.

FIG. 8 shows, in a form of a table, experimental effects of the non-factoid question-answering system in accordance with the first embodiment of the present invention.

FIG. 9 is a graph showing performance of the non-factoid question-answering system in accordance with the first embodiment of the present invention compared with a prior art example.

FIG. 10 shows an appearance of a computer system realizing the non-factoid question-answering system in accordance with the first embodiment of the present invention.

FIG. 11 is a block diagram showing a hardware configuration of the computer system of which appearance is shown in FIG. 10.

FIG. 12 is a block diagram schematically showing a configuration of a non-factoid question answering system in accordance with a second embodiment of the present invention.

FIG. 13 is a block diagram schematically showing a configuration of a similarity attention matrix generating unit shown in FIG. 12.

FIG. 14 is a schematic illustration showing a structure in the convolutional neural network shown in FIG. 12.

FIG. 15 is a flowchart representing a control structure of a program realizing, by a computer, the non-factoid question-answering system in accordance with the second embodiment of the present invention.

FIG. 16 shows the accuracy of answers provided by the non-factoid question-answering system in accordance with the second embodiment compared with the conventional method and with the accuracy of the first embodiment.

### DESCRIPTION OF EMBODIMENTS

In the following description and in the drawings, the same components are denoted by the same reference characters. Therefore, detailed description thereof will not be repeated. In the embodiments below, causality will be described as an example of a first semantic relation expression. The present invention, however, is not limited to such embodiments. As will be described later, material relation (example: <produce B from A> (corn, biofuel), necessity relation (example: <A is indispensable for B> (sunlight, photosynthesis), use relation (example: <use A for B> (iPS cells, regenerative medicine) and prevention relation (example: <prevent B by A> (vaccine, influenza) or any combination of these may be used.

[Basic Concept]

The causality expression such as CE1 mentioned above can be restated as “Tsunamis are generated because earthquakes disturb the sea bed and vertically the displace surrounding sea water” (CE2) (with a clue “because”). Note that such sentences may appear in a context unrelated to the 2011 East Japan Earthquake and that this expression alone may not adequately answer the question above. However, if we can automatically recognize such causality expressions with explicit clues and to somehow complement implicitly expressed causalities without such explicit clue, the accuracy of answers will be improved in why-question answering tasks.

In the following embodiment, a causality expression relevant to both an input question and an answer passage is selected from a large number of text archive including explicit clues. An answer passage refers to a text passage extracted from existing documents as a possible answer to a question. The selected causality expression is input along with the question and its answer passage to a convolutional neural network. A score indicating probability that it is a correct answer to the question is added to each answer passage, and an answer that seems to be the best answer to the question is selected. In the following description, causality expressions extracted from a text archive are called archive causality expressions, and causality expressions extracted from answer passages are called in-passage causality expressions. In the following embodiment, archive causality expressions that are most relevant to both a question and its answer passage are extracted and used. They will be called relevant causality expressions.

Further, in the following embodiment, we adopt an idea of using archive causality expressions as complements of implicitly expressed causality. For example, we note that the answer passage posted above and the causality expression CE2 including an explicit clue share common words (sea and water). Such common words should be used as clues to find adequate answers even if it is difficult to recognize implicit causality expressions. In other words, even if our method fails to recognize implicit causality expression in an answer passage, an archive causality expression including an explicit clue may be inferred as a paraphrase or restatement by paying sufficient attention to words commonly shared by archive causality expressions and an answer passage and, as a result, the accuracy to the question can be improved. In the present Specification, such an idea is referred to as the Causality Attention (hereinafter also denoted as “CA”).

Specifically, we assume that such common words as sea and water are associated with the causality between questions and their answers directly or indirectly. In the present Specification, such common words are called CA words (Causality Attention words) and are extracted from archive causality expressions. In the following embodiment, a classifier concentrates on such CA words, when causes or reasons of a given question are to be found during answer selection. To realize such a function, in the following embodiment, a Multi-Column Neural Network (MCNN) comprised of a plurality of convolutional neural networks is used as a classifier, as will be described later. This MCNN pays attention to CA words and is hence referred to as the CA-MCNN.

### First Embodiment

[Configuration]

<Non-Factoid Type Question-Answering System 30]

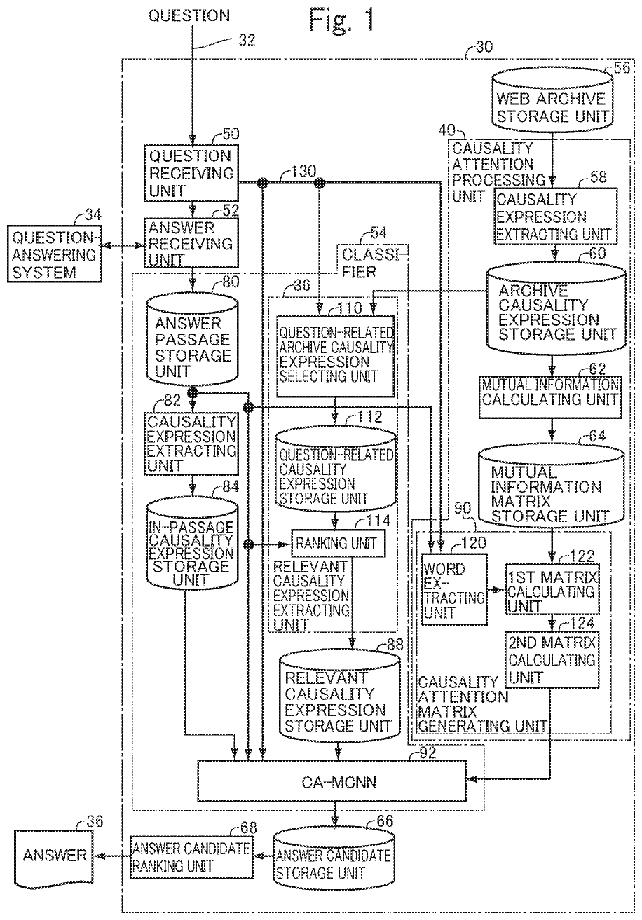

Referring to FIG. 1, a non-factoid question-answering system 30 in accordance with a first embodiment of the present invention includes: a question receiving unit 50 receiving a question 32; an answer receiving unit 52, applying the question received by question receiving unit 50 to an conventional question-answering system 34 and receiving a prescribed number of answer passages to the question 32 in any form from question-answering system 34; a web archive storage unit 56 storing a web archive including a huge number of documents; and a causality attention processing unit 40 for calculating a causality attention matrix, which will be described later, using the web archive stored in web archive storage unit 56, the question 130 received by question receiving unit 50 and the answer passages received by answer receiving unit 52 from question-answering system 34.

Causality attention processing unit 40 includes: a causality expression extracting unit 58 for extracting causality expressions using clues and the like by an conventional technique from web archive storage unit 56; an archive causality expression storage unit 60 storing causality expressions (archive causality expressions) extracted by causality expression extracting unit 58; a mutual information calculating unit 62 for extracting words included in an archive causality expression stored in archive causality expression storage unit 60 and calculating mutual information as a measure indicating correlation between words normalized by [1, −1]; a mutual information matrix storage unit for storing a mutual information matrix having words arranged in one and the other axes and having, at an intersection between the one and the other axes, mutual information of the pair of words on the one and the other axes arranged; and a causality attention matrix generating unit 90 for generating a causality attention matrix used for calculating a score as an evaluation value of each answer passage to the question 130, using the mutual information matrix stored in mutual information matrix storage unit 64, the question 130 received by question receiving unit 50 and answer passages obtained for question 130. Configuration of causality attention matrix generating unit 90 will be described later. While the mutual information as a measure indicating correlation between words obtained from causality expressions is used as the causality attention in the present embodiment, any other measures may be used as the measure indicating correlation. For example, other measure indicating correlation such as co-occurrence frequency of words in a set of causal expressions, Dice coefficient, and Jaccard coefficient may be used.

Non-factoid question-answering system 30 further includes: a classifier 54 calculating and outputting scores of answer passages to question 32 using the answer passages received by answer receiving unit 52, question 130 received by question receiving unit 50, archive causality expressions stored in archive causality expression storage unit 60, and the causality attention matrix generated by causality attention matrix generating unit 90; an answer candidate storage unit 66 for storing, as answer candidates to question 32, the scores output from classifier 54 and answer passages in association with each other; and an answer candidate ranking unit 68 sorting the answer candidates stored in answer candidate storage unit 66 in descending order in accordance with the scores and outputting an answer candidate having the highest score as an answer 36. <Classifier 54>

Classifier 54 includes: an answer passage storage unit 80 for storing answer passages received by answer receiving unit 52; a causality expression extracting unit 82 for extracting causality expressions included in the answer passages stored in answer passage storage unit 80; and an in-passage causality expression storage unit 84 for storing causality expressions extracted from answer passages by causality expression extracting unit 82. The causality expressions extracted from answer passages are referred to as the in-passage causality expressions.

Classifier 54 further includes: a relevant causality expression extracting unit 86 for extracting the most relevant archive causality expression for a combination of the question 130 received by question receiving unit 50 and each of the answer passages stored in answer passage storage unit 80, from archive causality expressions stored in archive causality expression storage unit 60; and a relevant causality expression storage unit 88 for storing causality expressions extracted by relevant causality expression extracting unit 86. The archive causality expressions extracted by relevant causality expression extracting unit 86 are considered as restatements of the in-passage causality expressions.

Classifier 54 further includes: a neural network 92 trained in advance to output, upon receiving the question 130 received by question receiving unit 50, the in-passage causality expressions stored in in-passage causality expression storage unit 84, the relevant causality expressions stored in relevant causality expression storage unit 88 and the causality attention matrix generated by causality attention matrix generating unit 90, a score indicating the probability that each of the answer passages stored in answer passage storage unit 80 is a correct answer to question 130.

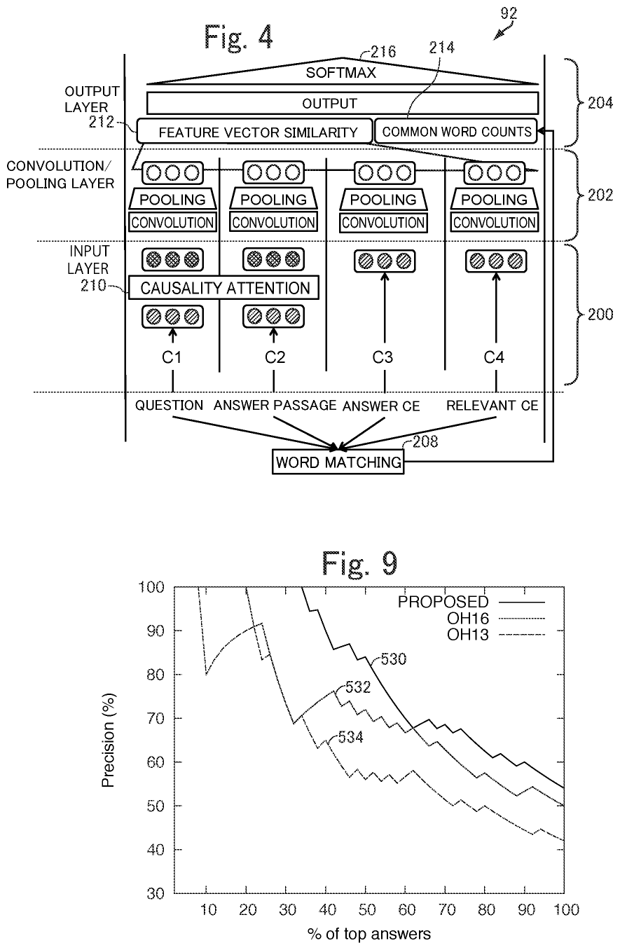

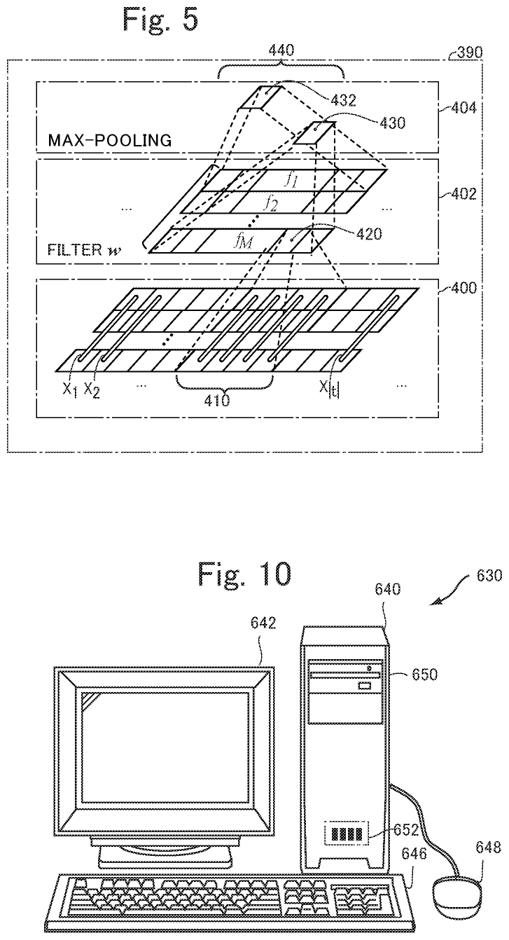

Neural network 92 is a multi-column convolutional neural network, as will be described later. Based on the causality attention generated by causality attention matrix generating unit 90, neural network 92 calculates the score noting especially the word considered to be most relevant to a word included in question 130, among the answer passages stored in answer passage storage unit 80. Humans seem to select a word that is considered to be relevant to a word in question 130 based on his/her common sense related to causality. In the present embodiment, evaluating an answer passage noting words in the answer passage based on the mutual information is referred to as the causality attention, as already described above. Further, the multi-column neural network 92 that scores answer passages using the causality attention is called CA-MCNN. The configuration of neural network 92 will be described later with reference to FIGS. 4 and 5. «Relevant Causality Expression Extracting Unit 86»

Relevant causality expression extracting unit 86 includes: a question-related archive causality expression selecting unit 110 for extracting content words from question 130 received by question receiving unit 50, and selecting, from archive causality expressions stored in archive causality expression storage unit 60, those having the words extracted from question 130 in their effect parts; a question-related causality expression storage unit 112 for storing the archive causality expressions selected by question-related archive causality expression selecting unit 110; and a ranking unit 114 ranking, for each of the answer passages stored in answer passage storage unit 80, the question-related causality expressions stored in question-related causality expression storage unit 112 in accordance with a prescribed equation indicating how many common words are shared by the answer passage, and selecting and outputting the top question-related causality expression as the causality expression relevant to the set of question and answer passage. The prescribed equation used for ranking by ranking unit 114 is weighted word count wgt-wc (x, y) represented by the following equation. In addition to weighted word count wgt-wc (x, y), three other evaluation values we (x, y), ratio (x, y) and wgt-ratio (x, y) are defined below. These are all input to neural network 92.

$$\begin{matrix}wc ( x , y ) = \vert M W ( x , y ) \vert & ( 1 ) \\ wgt \text{-} wc ( x , y ) = {\sum }_{mw ∈ M W ( x , y )} idf ( mw ) & \\ ratio ( x , y ) = \frac{\vert M W ( x , y ) \vert}{Word ( x )} & \\ wgt \text{-} ratio ( x , y ) = \frac{{\sum }_{mw ∈ M W ( x , y )} idf ( mw )}{{\sum }_{m w ∈ Word ( x )} idf ( xw )} . & \end{matrix}$$

where MW (x, y) is a set of content words in expression x that also occur in expression y, Word (x) is a set of content words in expression x, and idf (x) is inverse document frequency of word x. In the process by ranking unit 114, x represents the cause part of question-related causality, and y represents an answer passage.

Question-Related Archive Causality Expression Selecting Unit 110

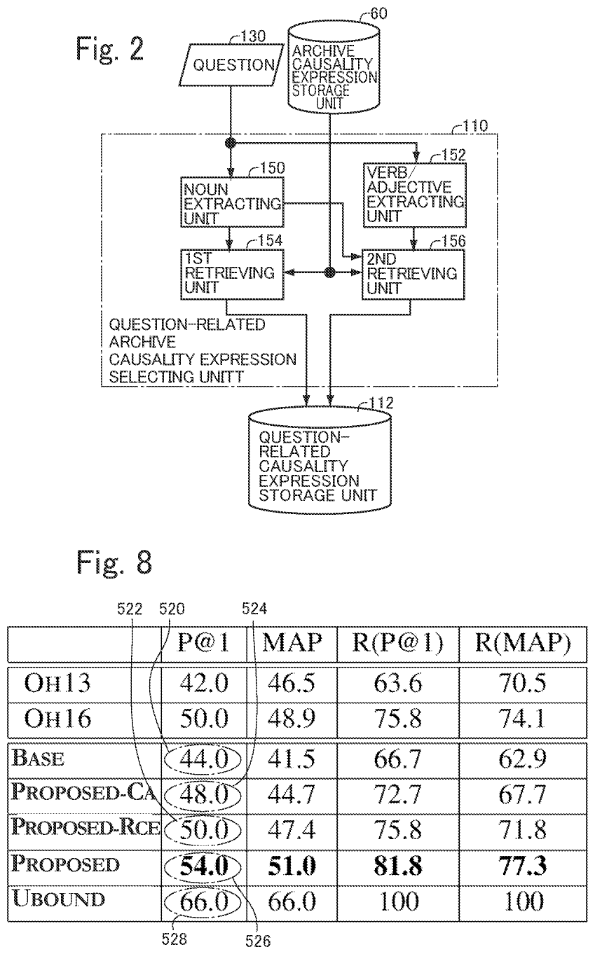

FIG. 2 schematically shows a configuration of question-related archive causality expression selecting unit 110 in relevant causality expression extracting unit 86. Referring to FIG. 2, question-related archive causality expression selecting unit 110 includes: a noun extracting unit 150 configured to receive question 130 from question receiving unit 50 for extracting any noun included in question 130; a verb/adjective extracting unit 152 for extracting any verb and adjective included in question 130; a first retrieving unit 154 searching and retrieving, from archive causality expression storage unit 60, an archive causality expression that includes in its effect part all the nouns extracted by noun extracting unit 150 and storing it in question-related causality expression storage unit 112; and a second retrieving unit 156 for searching for and extracting, from archive causality expression storage unit 60, an archive causality expression that includes in its effect part all the nouns extracted by noun extracting unit 150 and at least one of the verbs and adjectives extracted by verb/adjective extracting unit 152 and storing it in question-related causality expression storage unit 112. «Causality Attention Matrix Generating Unit 90»

In the present embodiment, based on the concept of causality attention, CA words included in a question and its answer passages get more weight at the time of scoring answer passages by neural network 92. For this purpose, the mutual information matrix is used. The weight here indicates how strongly the CA word included in the question and the CA word included in its answer passage are causally associated, and in the present embodiment, word-to-word mutual information is used as its value.

Let P (x, y) represent the probability that words x and y are respectively in the cause and effect parts of the same archive causality expression. This probability can be statistically obtained from all archive causality expressions stored in archive causality expression storage unit 60 shown in FIG. 1. Let P (x, *) and P (*, y) respectively be the probabilities that word x appears in the cause part and word y appears in the effect part over all the archive causality expressions. The strength of the causal association between words x and y is computed using the point-wise mutual information (npmi) normalized in the range of [−1, 1] given below.

$$\begin{matrix}npmi ( x ; y ) = \frac{pmi ( x ; y )}{- log [ P ( x , y ) ]} & ( 2 ) \\ pmi ( x ; y ) = log \frac{P ( x , y )}{P ( x , *) P (* , y )} & \end{matrix}$$

In the present embodiment, two types of causality attention matrixes are used as will be described in the following. The first is a word-to-word matrix A, and the second is a word-to-sentence matrix \hat{ }A. The word-sentence matrix \hat{ }A further has two types. One is a matrix \hat{ }Aq viewed from each word in a question, consisting of maximum values of mutual information with respect to each word in an answer passage, and the other is a matrix \hat{ }Ap viewed from each word of an answer passage, consisting of maximum values of mutual information with respect to each word in a question (here, the hat symbol “\hat{ }” is originally intended to be put directly above the immediately following letter).

Matrix A∈R^{|p|×|q|} where q represents a question and p represents an answer passage can be given by the following equation.

$$A [ i , j ] = \{ \begin{matrix}npmi ( {p}_{i} ; {q}_{j} ) & if npmi ( {p}_{i} ; {q}_{j} ) > 0 ; \\ 0 , & otherwise\end{matrix} . \qquad ( 3 )$$

where qj and pi are respectively the j-th word in question and i-th word in answer passage. Note that A[i, j] is only filled with npmi (·) if npmi (·)>0, and it is 0 otherwise. Therefore, only the CA words with npmi (·)>0 affect the causality attention of the present embodiment. An embodiment is also possible in which a value is input to matrix A[i, j] even when npmi <0. In experiments, we found better results when npmi (·)<0 was replaced by 0 as in Equation (3) and, hence, the restriction of Equation (3) is applied to A[i, j] in the present embodiment.

Given matrix A, causality-attention representations x′_{q}∈R^{d×|q|} and x′ₚ∈R^{d×|p|} for a pair of question q and answer passage p are given by Equations (4) and (5) below.

x′_{q}=W′_{q}·A (4)

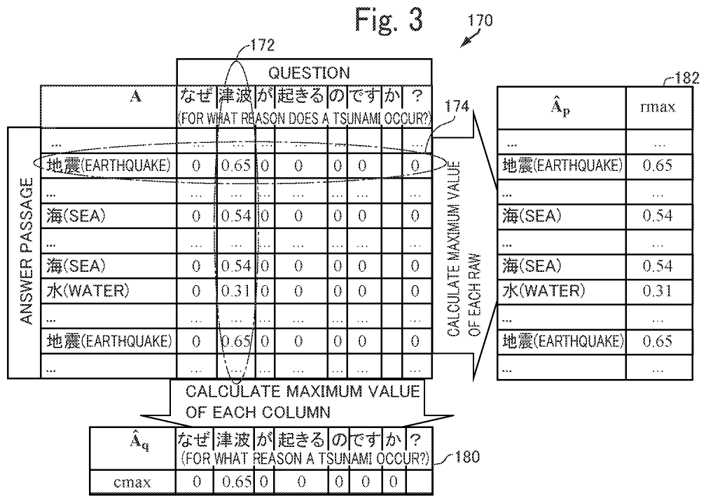

x′ₚ=W′ₚ·A^{T} (5)

where weight matrixes W′_{q}∈R^{d×|p|} and W′ₚ∈R^{d×|q|} are the parameters to be learned in training. The causality-attention representation of x′ is combined with the representation by embedding vectors x using element-wise addition ⊕ to get causality-attention weighted word embedding vector \hat{x}′:\hat{x}′=x⊕x′.
Question word qj (or answer-passage word pi) is likely to get high attention weights in the causality-attention representation if many words, which are causally associated with the word qj (or pi) appear in the counterpart text, that is, the answer passage (or the question). However, since only a few causally associated word pairs usually appear in a pair of question and its answer passage, the matrix A is sparse. This makes it difficult to effectively learn model parameters W_{q}′ and Wₚ′. To address this problem, the above-described matrixes \hat{ }A_{q} and \hat{ }Aₚ (collectively denoted as \hat{ }A) are generated from matrix A and used. These will be described later with reference to FIG. 3.

Referring to FIG. 1, causality attention matrix generating unit 90 of causality attention processing unit 40 includes: a word extracting unit 120 for extracting, for each combination of question 130 from question receiving unit 50 and each of the answer passages stored in answer passage storage unit 80, all content words included therein; a first matrix calculating unit 122 calculating a first mutual information matrix having question words extracted by word extracting unit 120 arranged in rows and answer passage words arranged in columns and having at each intersection of rows and columns, mutual information of two words corresponding to that position read from mutual information matrix storage unit 64 with a negative value replaced by 0; and a second matrix calculating unit 124 calculating two second mutual information matrixes in a manner as will be described below, from the first mutual information matrix calculated by the first matrix calculating unit 122. Since the negative value of mutual information is replaced by 0, the value of mutual information in the first mutual information matrix is normalized in the range of [0, 1].

Referring to FIG. 3, a first mutual information matrix A170 has words extracted from a question arranged in rows, words extracted from an answer passage to be processed in columns, and storing, at each of the intersections, mutual information of words corresponding to the intersecting position read from mutual information matrix storage unit 64 where each of the minus values are replaced with a zero. In contrast, the second matrix includes two matrixes, \hat{ }A_{q} 180 and \hat{ }Aₚ182. Matrix \hat{ }A_{q} 180 is built by obtaining the maximum value of mutual information stored in respective columns corresponding to words included in a question, from mutual information matrix A 170. Matrix \hat{ }Aₚ 182 is built by obtaining the maximum value of mutual information stored in respective rows corresponding to words included in an answer passage, from mutual information matrix A 170. Therefore, both in matrixes \hat{ }A_{q} 180 and \hat{ }Aₚ 182, the value of mutual information is normalized to [0, 1].

The causality-attention feature of a word in a question (called “question word”) is represented by the npmi value, which is the highest among all possible pairs of the question word and the word in all the answer passages (called “answer word”) in matrix \hat{ }A. Similarly, the causality-attention feature of an answer word is represented by the npmi value, which is the highest among all possible pairs of the answer word and all the question words in matrix \hat{ }A. This implies that the causality-attention feature of a word in matrix \hat{ }A is represented by extracting its most important causality-attention feature from matrix A.

By this process, two causality-attention feature matrixes are obtained. One is for a question, \hat{ }A_{q} 180, and the other is for answer passage, \hat{ }Aₚ 182.

Âₚ∈R^{|p|-i} is defined as

Âₚ[i, 1]=rmax(A[i, *])

where rmax(·) is a function that takes the maximum value from a row vector.
Similarly, Â_{q}∈R^{1×|q|} is defined as

Â_{q}[1, j]=cmax(A[*, j])

where cmax(·) is a function that takes the maximum value from a column vector. By way of example, look at the column 172 (which corresponds to “tsunami”) downward. The maximum value of mutual information is “0.65” of “earthquake.” Namely, the question word “tsunami” has the strongest causality relation with the answer word “earthquake.” By taking column-wise maximum values in the similar manner, we obtain a matrix \hat{ }A_{q}180. Similarly, look at the row 174 (which corresponds to “earthquake”) widthwise. The maximum value is “0.65” of “tsunami.” Namely, the question word that has the strongest causality relation with the answer word “earthquake” is “tsunami.” By taking these row-wise, we obtain a matrix \hat{ }Aₚ182. Actually, matrix \hat{ }A_{q}180 is a row vector of one row and matrix \hat{ }Aₚ182 is a column vector of one column, as can be seen from FIG. 3.

Given Â_{q}∈R^{1×|q|} and Âₚ∈R^{|p|×1}, we generate causality attention vectors x_{q}ⁿ∈R^{d×|q|} and xₚⁿ∈R^{d×|p|} for a pair of question q and answer passage p by the equations (6) and (7) below.

x_{q}ⁿ=W_{q}ⁿ·Â_{q} (6)

xₚⁿ=Wₚⁿ·Â_{q}^{T} (6)

where W_{q}ⁿ∈R^{d-1} and Wₚⁿ∈R^{d-1} are the parameters of the model to be learned in the training.

Finally, we combine these two vectors for the pair of question q and answer passage p (vector x by word embedding and causality attention vector x″ with matrix \hat{ }A) with element-wise addition as represented by equation (8) below, and the result is given as the input of columns C1 and C2 to the convolution/pooling layer 202 of convolutional neural network 92, which will be described later.

\hat{x}″=x⊕x″ (8)

### <Convolutional Neural Network>

Referring to FIG. 4, as will be described later, neural network 92 shown in FIG. 1 includes: an input layer 200 receiving a question, an answer passage, in-passage causality expressions (passage CEs) and relevant causality expressions (relevant CEs) and generating a word vector weighted by causality attention; a convolution/pooling layer 202 receiving an output from input layer 200 and outputting a feature vector; and an output layer 204 receiving an output from convolution/pooling layer 202 and outputting a probability that the input answer is a correct answer to the input question. Neural network 92 has four columns C1 to C4.

«Input Layer 200»

Input layer 200 includes a first column C1 to which a question is input; a second column C2 to which an answer passage is input; a third column C3 to which in-passage causality expressions (passage CEs) are input; and a fourth column C4 to which relevant causality expressions (relevant CEs) are input.

The first and second columns C1 and C2 respectively have a function of receiving inputs of word sequences forming the question and the answer passage, and converting them to word vectors, and a function 210 of weighting each word vector by the above-described causality attention. The third and fourth columns C3 and C4 do not have the function 210 of weighting by the causality attention, while they have a function of converting word sequences included in the in-passage causality expressions and relevant causality expressions to word-embedding vectors.

In the present embodiment, the i-th word in a word sequence t is represented by a d-dimensional word embedding vector xi (in an experiment described later, d=300). The word sequence is represented by the word embedding vector sequence X with d×|t|, where |t| is the length of word sequence t. Then, vector sequence X can be given by Equation (9) below.

x_{1:|t|}=x₁⊗x₂⊗ . . . x_{|t|}; (9)

where ⊗ is the concatenation operator. x_{i:i+j} is the concatenated embedding of xᵢ, . . . , xᵢ₊ⱼ, where embeddings with i<1 or i>|t| are set to zeroes (zero-padding).

Causality attention is given to the words in a question and its answer passage. In the present embodiment, attention vectors X′ with dimension d×t for word sequence t is computed using CA words. CA words are associated directly or indirectly with the causalities between the question and its possible answers, and are extracted automatically from archive causality expressions. Here, we apply element-wise addition to word embedding vector sequences X and attention vector sequences X′ for word sequence t to obtain weighted word embedding vector sequences \hat{ }X. «Convolution/Pooling Layer 202»

Convolution/pooling layer 202 includes four convolutional neural networks provided respectively for four columns C1 to C4, and four pooling layers receiving outputs of these and outputting results of max-pooling.

Specifically, referring to FIG. 5, a certain column 390 in convolution/pooling layer 202 consists of an input layer 400, a convolution layer 402 and a pooling layer 404. It is noted, however, that convolution/pooling layer 202 is not limited to such a configuration, and there can be several sets of these three layers.

A word vector sequence X₁, . . . , X_{|t|} is input to input layer 400 from corresponding columns of input layer 200. This word vector sequence X₁, . . . , X_{|t|} is represented as a matrix T=[X₁, X₂, . . . , X_{|t|} ]^{T}. The matrix T is subjected to M feature maps f₁ to f_{M} by the next convolution layer 402. Each feature map is a vector, and a vector as an element of each feature map is computed by a filter denoted by w from n-gram 410 of continuous word vectors while moving n-gram 410 and obtaining respective outputs, where n is a natural number. When we represent an output of feature map f by O, the i-th element Oᵢ of O is given by Equation (10) below.

oᵢ=f(·x_{i:i+n-1}+b) (10)

where · means element-wise multiplication followed by summation of the results, and f(x)=max (0, x) (normalized linear function). Further, filter w is a d×n dimensional real-number weight matrix where d is the number of elements of word vector, and bias b∈R is a real-number vector term.

It is noted that n may be the same or different for all the feature maps. Appropriate value of n may be 2, 3, 4 or 5. In the present embodiment, filter weight matrix is the same for every convolutional neural network. Though these may be different from each other, the accuracy becomes higher when the weight matrix is the same than when each weight matrix is learned independently.

For each of the feature maps, the next pooling layer 404 performs a so-called max-pooling. Specifically, pooling layer 404 selects the maximum element 420 among the elements of feature map f_{M}, and takes it out as an element 430. By performing this process on each of the feature maps, elements 430, . . . , 432 are taken out and these are concatenated in order from f₁ to f_{M} and output as a vector 440 to output layer 204 shown in FIG. 4. Vectors 440 and so on obtained in this manner are output from respective pooling layers to output layer 204. «Output Layer 204»

In output layer 204, similarities of these feature vectors are calculated by a similarity calculating unit 212 and applied to a Softmax layer 216. Further, word matching 208 is conducted among word sequences applied to four columns C1 to C4, a counting unit 214, which counts the number of common words, calculates four values represented by Equation (1) as indications of the number of common words, and applies these to Softmax layer 216. Softmax layer 216 applies a linear softmax function to the inputs and outputs a probability that an answer passage is a correct answer to the question.

In the present embodiment, similarity between two feature vectors is calculated in the following manner. Other than the similarity described below, other type of similarities such as cosine similarity, may be applicable.

The similarity between two feature vectors vᵢⁿ and vⱼⁿ obtained with filters having the same window size n (n-gram) is calculated by Equation (11) below, where vᵢⁿ represents feature vector of n-gram obtained from the i-th column and vⱼⁿ represents feature vector of n-gram obtained from the j-th column.

$$sim ( {v}_{i}^{n} , {v}_{j}^{n} ) = \frac{1}{1 + ED ( {v}_{i}^{n} , {v}_{j}^{n} )} \qquad ( 11 )$$

where ED(·) is the Euclidean distance.

In the present embodiment, the similarity is used for calculating four types of similarity scores sv₁(n)˜sv₄(n) below.

The similarity between two feature vectors vᵢⁿ and vⱼⁿ obtained with filters having the same window size n (n-gram) is calculated by the equations below.

| | |
|---|---|
| sv₁(n) = sim(v₁ⁿ,v₂ⁿ) | question and answer passage |
| sv₂(n) = sim(v₁ⁿ,v₃ⁿ) | question and in-passage causality expression |
| sv₃(n) = sim(v₁ⁿ,v₄ⁿ) | question and relevant causality expression |
| sv₄(n) = sim(v₂ⁿ,v₄ⁿ) | answer passage and relevant causality expression |

All these values are calculated by similarity calculating unit 212 and applied to output layer 204.

Though only the similarities of feature vectors as described above are used as inputs to output layer 204 in the present embodiment, the input information is not limited thereto. For example, feature vectors themselves may be used, or a combination of feature vectors and their similarities may be used.

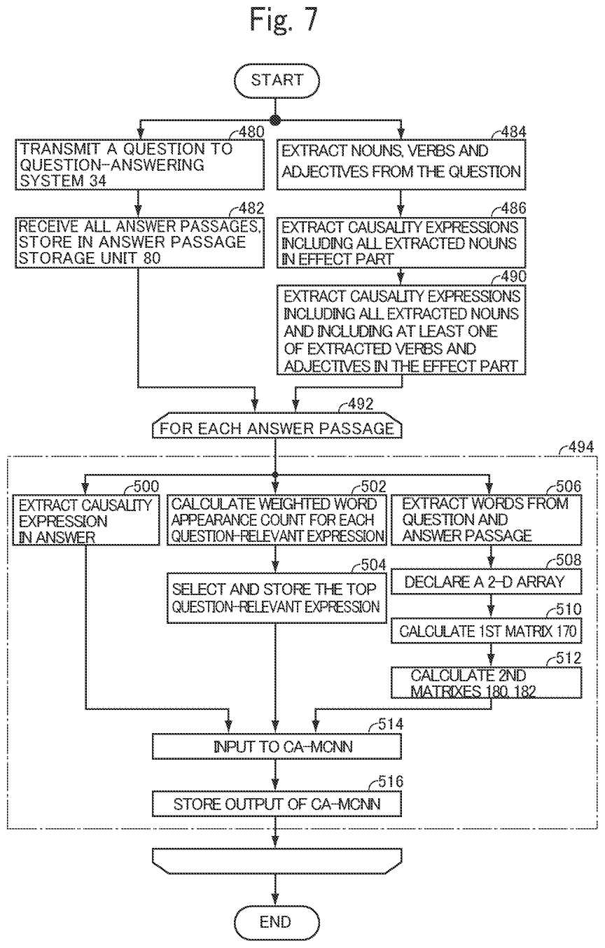

FIG. 7 is a flowchart representing a control structure of a computer program realizing, by a computer, the non-factoid question-answering system 30. The description related to the configuration of computer program shown in FIG. 7 partially overlap with the description of the operation of non-factoid question-answering system 30 and, therefore, it will be described together with the description of the operation.

[Operation]

The operation of non-factoid question-answering system 30 includes a training phase and a service phase in which a response is output to an actual question.

<Training Phase>

Referring to FIG. 1, before a question 32 is given, archive causality expressions are extracted from web archive storage unit 56 by causality expression extracting unit 58, and mutual information matrix is calculated by mutual information calculating unit 62 and stored in mutual information matrix storage unit 64.

The weight parameters used in the first and second matrix calculating units 122 and 124 are trained by training data comprised of training questions and answer passages thereto, as well as labels prepared manually, indicating whether each answer is a correct answer to the question. Neural network 92 is also trained beforehand by using error back propagation method as in the case of a common neural network, to output a probability that a combination of an input question and an answer passage, input by using similar training data, is a correct combination.

<Service Phase>

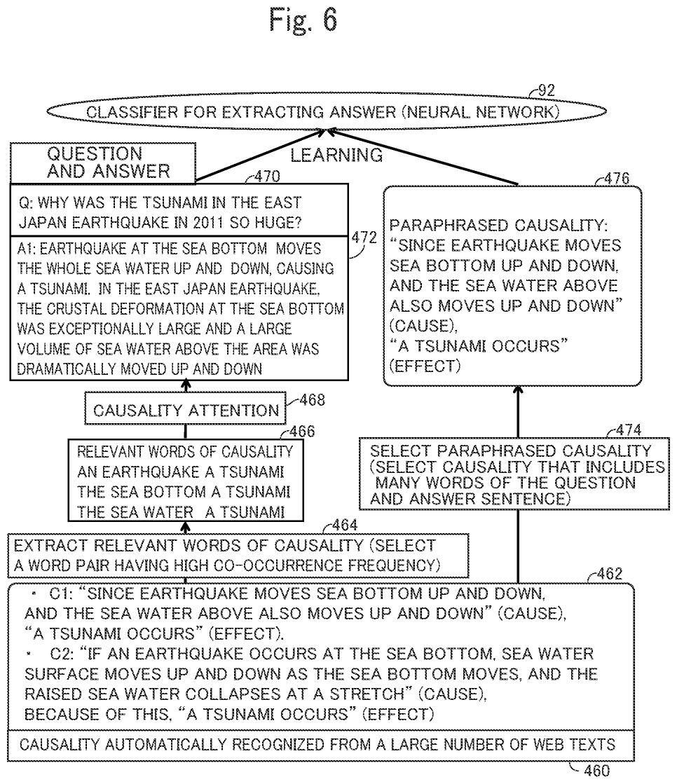

The operation of non-factoid question-answering system 30 in the service phase will be outlined with reference to FIG. 6. First, by a process 460 of automatically recognizing causality expressions from a large number of text archive, a large number of archive causality expressions 462 are collected. From these, word pairs having high causality relevance are selected based on co-occurrence frequency, and thereby relevant words 466 of causality are extracted, by a process 464. From these relevant words 466, information representing causality attention 468 can be obtained. By the causality attention 468, heavier weight than others is given to a word that is especially notable as representing causality in a question and an answer passage.

On the other hand, when a set of question 470 and an answer passage 472 is given, a process 474 is conducted, in which a causality including many words that are included in the question and the answer passage is selected, from the archive causality expressions 462 extracted from the archive. As a result, a paraphrase expression 476 (relevant causality expression) of in-passage causality expression in the answer passage are obtained.

The question 470, answer passage 472, a causality expression included in the answer passage, causality attention 468 and paraphrase expression of causality corresponding to the answer passage (relevant causality expression) 476 are all applied to neural network 92. Neural network 92 calculates the probability that the answer passage 472 is a correct answer to the question 470. The probability is calculated for every answer passage, and the answer passage having the highest probability of being the correct answer is selected as the answer to the question 470.

More specifically, referring to FIG. 1, prior to the service phase, causality expression extracting unit 58 extracts archive causality expressions from the web archive and stores them in archive causality expression storage unit 60. Further, from the causality expressions stored in archive causality expression storage unit 60, mutual information calculating unit 62 calculates mutual information between words, and stores as mutual information matrix, in mutual information matrix storage unit 64.

When a question 32 is actually applied to question receiving unit 50, question receiving unit 50 applies this question to answer receiving unit 52. Answer receiving unit 52 transmits the question to question-answering system 34 (step 480 of FIG. 7). Question receiving unit 50 also applies this question 32 as a question 130 to relevant causality expression extracting unit 86, word extracting unit 120 of causality attention matrix generating unit 90 and neural network 92.

Answer receiving unit 52 receives a prescribed number (for example, twenty) of answer passages to the question 32 from question-answering system 34. Answer receiving unit 52 stores these answer passages in answer passage storage unit 80 of classifier 54 (step 482 of FIG. 7).

Referring to FIG. 2, noun extracting unit 150 of question-related archive causality expression selecting unit 110 receives question 130 from question receiving unit 50, extracts a noun included in question 130, and applies it to the first and second retrieving units 154 and 156. Verb/adjective extracting unit 152 extracts a verb and an adjective included in question 130 and applies them to the second retrieving unit 156 (step 484 of FIG. 7). The first retrieving unit 154 searches in archive causality expression storage unit 60 and retrieves an archive causality expression including in the effect part all the nouns extracted by noun extracting unit 150, and stores the retrieved archive causality expression in question-related causality expression storage unit 112 (step 486 of FIG. 7). The second retrieving unit 156 searches in archive causality expression storage unit 60 and retrieves an archive causality expression including all the nouns extracted by noun extracting unit 150 and including, in the effect part at least one of the verbs and adjectives extracted by verb/adjective extracting unit 152, and stores it in question-related causality expression storage unit 112 (step 490 of FIG. 7).

When all answer passages are received and all the processes by question-related archive causality expression selecting unit 110 are completed, then, on each answer passage stored in answer passage storage unit 80, the following process (process 494 shown in FIG. 7) is executed, at step 492.

First, causality expression extracting unit 82 extracts an in-passage causality expression from the answer passage as an object of processing, using an conventional causality expression extracting algorithm, and stores it in in-passage causality expression storage unit 84 (step 500 of FIG. 7). Ranking unit 114 calculates, for the answer passage as the object of processing, a weighted word appearance count wgt-wc (x, y) (step 502 of FIG. 7), and using the weighted word count, ranks the question-related causality expressions stored in question-related causality expression storage unit 112. Ranking unit 114 further selects and outputs the top question-related causality expression as the causality expression related to the set of the question and the answer passage that is being processed (step 504 of FIG. 7). Relevant causality expression storage unit 88 stores relevant causality expressions output, one for each answer passage, by relevant causality expression extracting unit 86.

In causality attention matrix generating unit 90 of causality attention processing unit 40, word extracting unit 120 extracts all words that appear in the question received by question receiving unit 50 and in the answer passage that is being processed, and applies them to the first matrix calculating unit 122 (step 506 of FIG. 7). The first matrix calculating unit 122 declares a two-dimensional array to generate a matrix having words in the question sentence in rows and words in the answer-passage that is being processed in columns (step 508 of FIG. 7). The first matrix calculating unit 122 further reads, for the cell at the intersection of these words, mutual information between corresponding words from mutual information matrix storage unit 64, and arranges the read values while replacing each of the negative values with a zero, and thereby generates a mutual information matrix A170 among these words (first matrix A170) (step 510 of FIG. 7). The second matrix calculating unit 124 calculates two second mutual information matrixes \hat{ }A_{q}180 (second matrix 180) and \hat{ }Aₚ182 (second matrix 182) by the method described previously from the first mutual information matrix calculated by the first matrix calculating unit 122 (step 512 of FIG. 7).

For the question 32, when the extraction of relevant archive causality expressions and calculation of mutual information matrixes A170, \hat{ }A_{q}180 and \hat{ }Aₚ182 are completed for every answer passage stored in answer passage storage unit 80 (when the processes of steps 500, 504 and up to 512 in FIG. 7 are all completed), referring to FIG. 4, a question received by question receiving unit 50 is applied to the first column of neural network 92. To the second column, an answer passage that is being processed is applied. To the third column, all in-passage causality expressions extracted from the answer passage and stored in in-passage causality expression storage unit 84 that are being processed are applied, concatenated with a prescribed delimiter. To the fourth column, a causality expression relevant to the answer passage that is being processed, stored in relevant causality expression storage unit 88 is applied (step 514 of FIG. 7).

These are all converted to word embedding vectors in the input layer 200 of neural network 92. Word embedding vectors of respective words forming the questions of the first column and the answer passages of the second column are each multiplied by the weight obtained from mutual information matrixes \hat{ }A_{q} and \hat{ }Aₚ. In the output layer 204 of neural network 92, first, four types of similarity scores sv₁(n) to sv₄(n) of these feature vectors are calculated and output to Softmax layer 216. As already described, not the similarity scores as described here but feature vectors themselves, or a combination of feature vectors and scores may be input to Softmax layer 216.

Further, the word sequences applied to the first to fourth columns are subjected to word matching as described above, and four values represented by Equation (1) as the indexes of the number of common words, are given to output layer 204.

Based on the output from output layer 204, Softmax layer 216 outputs a probability that the input answer passage is a correct answer to the question. This value is accumulated with each answer candidate in answer candidate storage unit 66 shown in FIG. 1 (step 516 shown in FIG. 7).

When the above-described processes are all completed on the answer candidates, answer candidate ranking unit 68 sorts the answer candidates stored in answer candidate storage unit 66 in descending order in accordance with the scores, and outputs the answer candidate of the top score or N top answer candidates (N>1) as an answer or answers 36.

[Experiments]

In the following, by way of example, results of experiments conducted using the configurations of the present embodiment will be described. In the experiment, 850 questions and their top twenty answer passages (17,000 question-passage pairs in total) were used. Of this data, 15,000 pairs were used as training data, 1,000 pairs were used as development data and the remaining 1,000 pairs were used as test data. The development data was used to determine several hyper-parameters (window size for the filters, the number of filters and the number of mini-batches) of neural network 92.

For the parameters of filters, we used 3, 4 or 5 consecutive numbers from {2, 3, 4, 5, 6} for making filters with different window sizes, and the number of filters for each combination of filters was chosen from {25, 50, 75, 100}. The total possible number of hyper-parameter combinations was 120. We used all of them in the experiment, and selected the best setting by average precision on the development data. In all processes, a dropout of 0.5 was applied to the output layer. We ran ten epochs through all the training data, where each epoch consisted of many mini-batches.

For training neural network 92, mini-batch stochastic gradient descent was used, where weights for the filter W and the causality attention were initialized at random in the range of (−0.01, 0.01).

Evaluation was done by P@1 (precision of the top answer) and MAP (Mean Average Precision). P@1 indicates how many questions have a correct top answer. MAP measures the overall quality of the top n-answers ranked by the system, and it is calculated by the equation below.

$$MAP = \frac{1}{\vert Q \vert} {\sum }_{q ∈ Q} \frac{{\sum }_{k = 1}^{n} ( Prec ( k ) \times rel ( k ) )}{\vert {Answer}_{q} \vert}$$

where Q is the set of questions in the test data, Answer_{q} is the set of correct answers to question q∈Q, Prec(k) is the precision at cut-off k in the top n answer passages, rel(k) is an indicator that is 1 if the item at rank k is a correct answer and 0 otherwise.

FIG. 8 shows, in the form of a table, the results of the above-described embodiment and comparative examples. The comparative examples in the table are as follows.

<OH13> Supervised training system described in Non-Patent Literature 1. It is a SVM-based system using, as features, word n-grams, word classes, and in-passage causalities.

<OH16> Semi-supervised training system described in Reference 1 as listed below. For its semi-supervised learning, it uses the system of OH13 as its initial system and archive causality expressions for enlarging training data.

<Base> A baseline MCNN system that uses only questions, answer passages, in-passage causality expressions and their related common word counts as inputs. It uses neither the causality attention nor relevant causality expressions of the above-described embodiment.

<Proposed-CA> The system of the above-described embodiment, where only the relevant causality expressions are used and causality attention (CA) is not applied.

<Proposed-R_{CE}> The system of the above-described embodiment where only the causality attention is used and relevant causality expressions are not used.

<Proposed> The system of the above-described embodiment.

<Ubound> A system that always locates all the n correct answers to a question in the top n ranks if they are in the test data, and it indicates the upper bound of the answer selection performance of the present experiment.

As can be seen from FIG. 8, the system in accordance with the present embodiment consistently showed better performances than the conventional techniques. More specifically, it can be seen that by paraphrasing causality using relevant causality expressions, P@1 was improved by 4 to 6% (reference characters 520→524, 522→526 of FIG. 8). Further, by using causality attention, P@1 was improved by 6% (reference characters 520→522, 524→526).

Further, it can be seen from FIG. 8 that in the present invention, R(P@1) reaches 81.8% (54/66, reference characters 526 and 528). From this result, it was found that if at least one correct answer to the question can be found by the system of the present invention, it is possible to find the top answer with high precision, to a why-type question.

Further, in order to investigate the effect of the present invention on the quality of the top answers, the quality of top answers by OH13, OH16 and Proposed were compared. For this purpose, for each system, only the top answer for each question in the test data was selected, and all the top answers were ranked using their scores given by each system. Then, the precision rate at each rank of the ranked list of the top answers was calculated. The results are as shown in FIG. 9.

In FIG. 9, the x-axis represents the accumulative rate (percentage) of top answers against all the top answers in the ranked list, and y-axis represents the precision rate at a certain point on the x-axis. Referring to FIG. 9, when evaluating the top 30% of the answers, the present invention (graph 530) achieved 100% precision. This is much higher than OH13 (graph 534) and OH16 (graph 532). From these results, it can be understood that the quality of top answers is effectively improved by the system of the present invention.

[Computer Implementation]

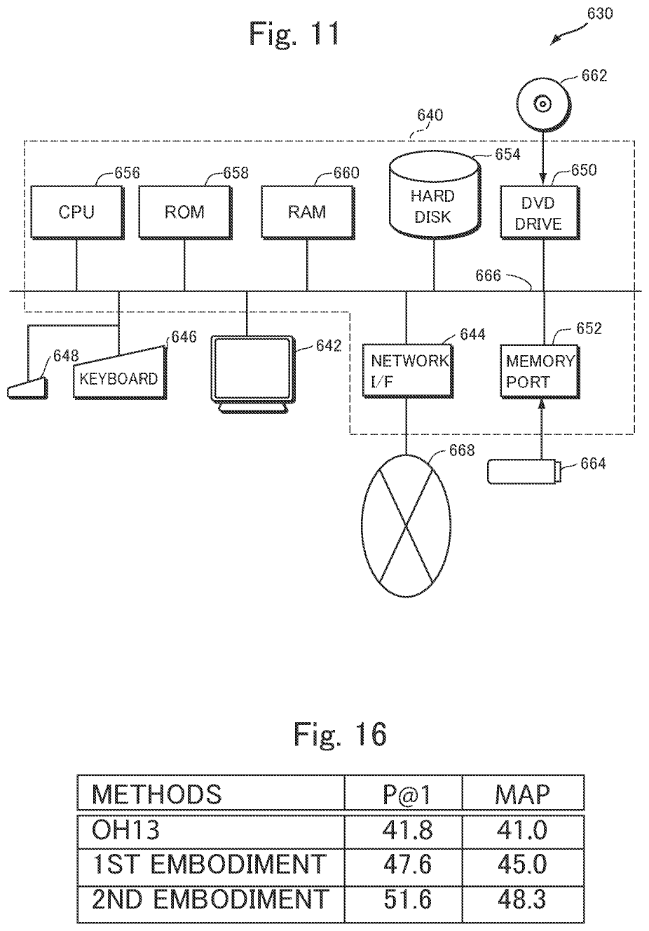

The non-factoid question-answering system 30 in accordance with the present embodiment can be implemented by computer hardware and computer programs executed on the computer hardware. FIG. 10 shows an appearance of computer system 630 and FIG. 11 shows an internal configuration of computer system 630.

Referring to FIG. 10, computer system 630 includes a computer 640 having a memory port 652 and a DVD (Digital Versatile Disk) drive 650, a keyboard 646, a mouse 648, and a monitor 642.

Referring to FIG. 11, computer 640 includes, in addition to memory port 652 and DVD drive 650, a CPU (Central Processing Unit) 656, a bus 666 connected to CPU 656, memory port 652 and DVD drive 650, a read only memory (ROM) 658 for storing a boot program and the like, a random access memory (RAM) 660 connected to bus 666, for storing program instructions, a system program and work data, and a hard disk 654. Computer system 630 further includes a network interface (I/F) 644 providing the connection to a network 668 allowing communication with another terminal.

The computer program causing computer system 630 to function as each of the functioning sections of the non-factoid question-answering system 30 in accordance with the embodiment above is stored in a DVD 662 or a removable memory 664 loaded to DVD drive 650 or to memory port 652, and transferred to hard disk 654. Alternatively, the program may be transmitted to computer 640 through network 668, and stored in hard disk 654. At the time of execution, the program is loaded to RAM 660. The program may be directly loaded from DVD 662, removable memory 664 or through network 668 to RAM 660.

The program includes a plurality of instructions to cause computer 640 to operate as functioning sections of the non-factoid question-answering system 30 in accordance with the embodiment above. Some of the basic functions necessary to cause the computer 640 to realize each of these functioning sections are provided by the operating system running on computer 640, by a third party program, or by various dynamically linkable programming tool kits or program library, installed in computer 640. Therefore, the program may not necessarily include all of the functions necessary to realize the system and method of the present embodiment. The program has only to include instructions to realize the functions of the above-described system by dynamically calling appropriate functions or appropriate program tools in a program tool kit or program library in a manner controlled to attain desired results. Naturally, all the necessary functions may be provided by the program alone.

### [Second Embodiment]

[Configuration]

In the first embodiment described above, only the causality attention is used as the attention. It has been confirmed by the experiment that use of this attention only is sufficient to improve the quality of answers in the non-factoid question-answering system as compared with the conventional examples. The present invention, however, is not limited to such an embodiment. An attention of other relation may be used. It is necessary, however, to use an attention that can lead to an answer candidate satisfying conditions as a correct answer to a why question.

Here, as to the relevance of correct answers to a why question, the following three aspects must be considered.

1) Relevance to the question's topic

2) Presentation of the reason or cause that the question asks

3) The causality between the reason or cause and the question's topic

If an answer candidate has all the three relevances, it can be regarded as providing a correct answer to a why question.

In the first embodiment described above, while 2) the presentation of the reason or cause and 3) the causality are taken into consideration, 1) the relevance to the question's topic is not explicitly considered. In the second embodiment, an attention related to the relevance to the question's topic is used, and an answer to the question is found by using this together with the causality attention. Specifically, an answer is found using not an attention from only a single point of view but attentions from mutually different points of view. For this purpose, in the second embodiment, for each word in the question and answer candidates, meanings of the word in contexts viewed from different points are particularly noted and used as attentions (weights) at the time of input to the neural network.

In the second embodiment, as a view point to topic relevance, the meaning of a word in a general text context is used. Specifically, we use not a specific semantic relation of a word such as causality, material relation or the like, but a semantic relation between words in a general context, free of such a specific semantic relation. The topic relevance is often judged by semantically similar words in a question and an answer. Such semantically similar words often appear in similar contexts. Therefore, as the topic relevance, we use similarity of word embedding vectors learned from general contexts (referred to as the “general word embedding vectors”).

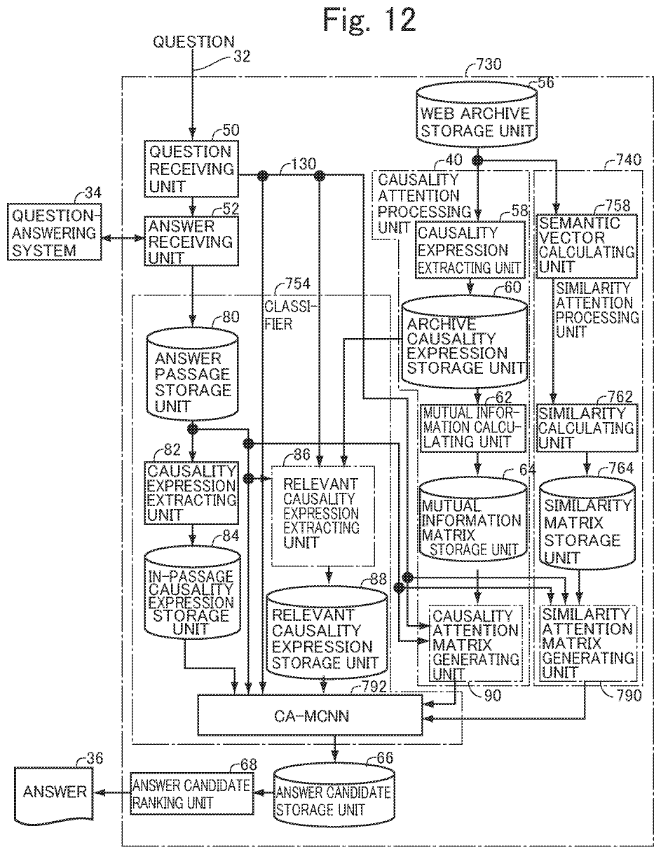

FIG. 12 shows a block diagram of a non-factoid question-answering system 730 in accordance with the second embodiment. Referring to FIG. 12, non-factoid question-answering system 730 is different from non-factoid question-answering system 30 shown in FIG. 1 in that in addition to the configuration of non-factoid question-answering system 30, it includes a similarity attention processing unit 740 that generates, in the similar manner as causality attention matrix generating unit 90 and causality attention processing unit 40, a similarity matrix between appearing words, for each combination of a question and an answer passage based on the web archive stored in web archive storage unit 56.

Non-factoid question-answering system 730 is different from non-factoid question-answering system 30 further in that it includes, in place of classifier 54 shown in FIG. 1, a classifier 754 having a function of calculating a score of an answer candidate using, simultaneously with the causality attention, the similarity attention generated by similarity attention processing unit 740.

Classifier 754 is different from classifier 54 only in that it includes, in place of neural network 92 of classifier 54, a neural network 792 that has a function of calculating a score of each answer passage by simultaneously using the similarity attention and the causality attention.

Similarity attention processing unit 740 includes a semantic vector calculating unit 758 calculating a semantic vector for each word appearing in text stored in web archive storage unit 56. In the present embodiment, general word embedding vector is used as the semantic vector.

Similarity attention processing unit 740 further includes: a similarity calculating unit 762 calculating similarity between semantic vectors of every combination of two words from these words, and thereby calculating the similarity between the two words; and a similarity matrix storage unit 764 for storing the similarity calculated for every combination of two words by similarity calculating unit 762, as a matrix having respective words arranged in rows and columns. The matrix stored in similarity matrix storage unit 764 has all the words appearing in non-factoid question-answering system 730 arranged in rows and columns, and stores, at each intersection between the row and the column of words, the similarity between the words.

Similarity attention processing unit 740 further includes a similarity attention matrix generating unit 790 for generating a matrix (similarity attention matrix) for storing similarity attention used for score calculation by neural network 792, using words respectively appearing in a question 130 from question receiving unit 50 and an answer passage read from answer passage storage unit 80 as well as the similarity matrix stored in similarity matrix storage unit 764. When the score of each answer passage to question 130 is to be calculated, neural network 792 uses the similarity attention matrix calculated by similarity attention matrix generating unit 790 between the question 130 and its answer passage. The configuration of neural network 792 will be described later with reference to FIG. 14.

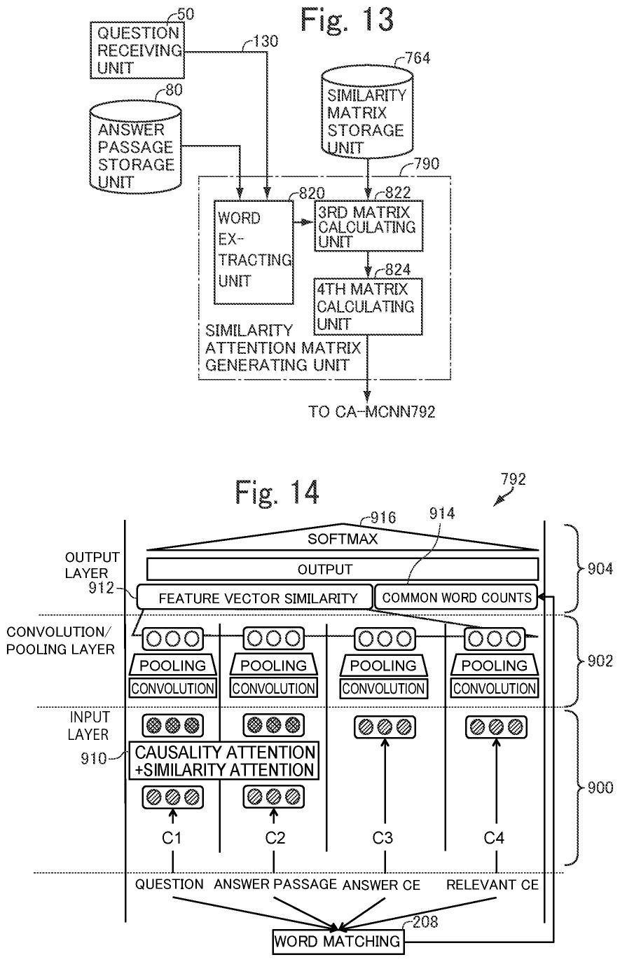

FIG. 13 is a block diagram showing the structure of similarity attention matrix generating unit 790. Comparing FIGS. 13 and 1, we can see that similarity attention matrix generating unit 790 and the causality attention matrix generating unit 90 shown in FIG. 1 have parallel structures.

Referring to FIG. 13, similarity attention matrix generating unit 790 includes: a word extracting unit 820 for extracting, from each combination of the question 130 from question receiving unit 50 and each of the answer passages stored in answer passage storage unit 80, all content words contained therein; a third matrix calculating unit 822 calculating a similarity matrix by arranging question words extracted by word extracting unit 820 in rows and answer passage words in columns, and reading from similarity matrix storage unit 764 and arranging at the intersections of rows and columns the similarities between the corresponding two words; and a fourth matrix calculating unit 824 calculating two fourth similarity matrixes by the method described below, from the similarity matrix calculated by the third matrix calculating unit 822. The value of similarity in every similarity matrix is normalized in the range of [0, 1].

The method of generating the two fourth similarity matrixes by the fourth matrix calculating unit 824 is the same as the method of generating the second matrixes 180 and 182 shown in FIG. 3. Therefore, detailed description thereof will not be repeated here.

FIG. 14 schematically shows a structure of neural network 792. The structure of neural network 792 shown in FIG. 14 is substantially the same as that of neural network 92 shown in FIG. 4. Neural network 792 is different from neural network 92 in that in place of input layer 200 of FIG. 4, it has an input layer 900. The third and fourth columns of input layer 900 are the same as those of input layer 200. The first column C1 and the second column C2 of input layer 900 are different from those of input layer 200 in that they have a function of receiving inputs of word sequences forming a question and an answer passage and converting these to word vectors, and a function 910 of adding a weight to each word vector by a value obtained by adding, element by element, the causality attention and the similarity attention described above. In the present embodiment, weights are added to both elements corresponding to the causality attention and the similarity attention, and thereafter, these two are added. The weights constitute part of the training parameters of neural network 792. Except for this point, neural network 792 has the same structure as neural network 92 shown in FIG. 4. Therefore, descriptions of common portions will not be repeated here.

[Operation]

Non-factoid question-answering system 730 in accordance with the second embodiment operates in the following manner.

The operation of non-factoid question-answering system 730 in the training phase is the same as that of non-factoid question-answering system 30. It is different, however, in that prior to training, semantic vector calculating unit 758 and similarity calculating unit 762 calculate a similarity matrix from texts stored in web archive storage unit 56 and store it in similarity matrix storage unit 764. Further, in non-factoid question-answering system 730, based on the similarity matrix and the mutual information matrix calculated from the texts stored in web archive storage unit 56, for each combination of a question and an answer passage of training data, the similarity attention and the causality attention are calculated, and neural network 792 is trained simultaneously using these. In this point also, training of non-factoid question-answering system 730 is different from that of non-factoid question-answering system 30.

During training, training data is used repeatedly to update parameters of neural network, 792 repeatedly, and when the amount of change of the parameters becomes smaller than a prescribed threshold value, the training ends. The end timing of training, however, is not limited to this. By way of example, training may end when training for a prescribed number of times using the same training data is completed.

The operation of non-factoid question-answering system 730 in the service phase is also the same as that of non-factoid question-answering system 30 of the first embodiment except that the similarity attention is used. More specifically, question receiving unit 50, answer receiving unit 52, answer passage storage unit 80, causality expression extracting unit 82, in-passage causality expression storage unit 84, relevant causality expression extracting unit 86, relevant causality expression storage unit 88 and causality attention processing unit 40 shown in FIG. 12 operate in the similar manner as in the first embodiment.

Semantic vector calculating unit 758 and similarity calculating unit 762 generate a similarity matrix and store it in similarity matrix storage unit 764 beforehand.

When a question 32 is applied to non-factoid question-answering system 730, answer passages to the question are collected from question-answering system 34 and in-passage causality expressions extracted therefrom are stored in in-passage causality expression storage unit 84, as in the first embodiment. Similarly, archive causality expressions are extracted from web archive storage unit 56, and based on the answer passages and question 130, relevant causality expressions are extracted from archive causality expressions and stored in relevant causality expression storage unit 88.

From the words obtained from question 130 and the answer passage, a causality attention matrix is generated by causality attention matrix generating unit 90. Similarly, a similarity attention matrix is generated by similarity attention matrix generating unit 790. These attentions are given to neural network 792. Neural network 792 receives each of the words forming the question and the answer passage, adds weights that are the sum of the causality attention and the similarity attention, and inputs them to a hidden layer of the neural network. As a result, a score for the pair is output from neural network 792.

In this manner, scores are calculated for all the pairs of the question and each of the answer passages, and pairs of top scores are stored in answer candidate storage unit 66. Then, answer candidate ranking unit 68 ranks the answer candidates, and the answer candidate at the top of the ranking is output as an answer 36.

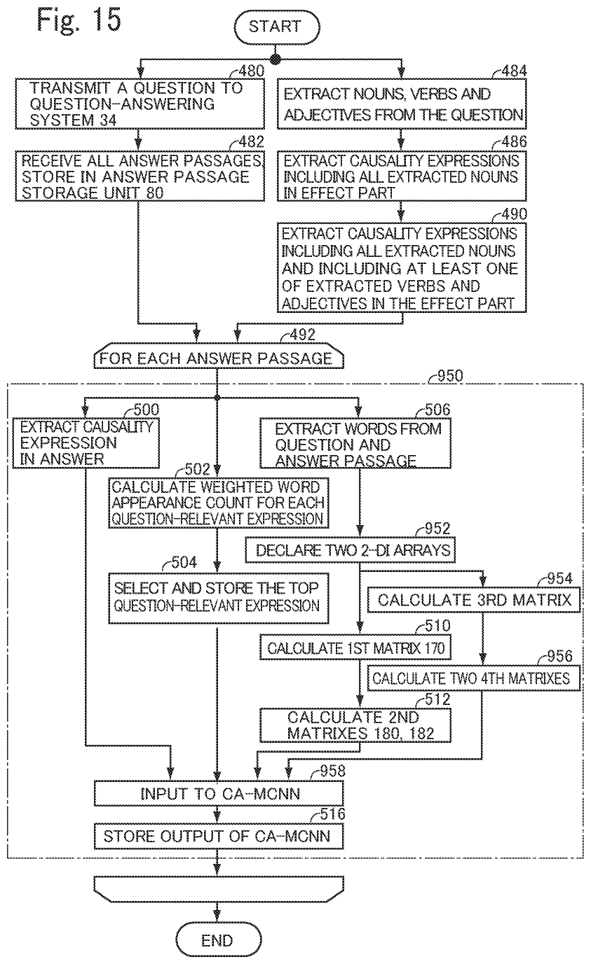

FIG. 15 shows, in the form of a flowchart, a control structure of a computer program for realizing the non-factoid question-answering system 730 in accordance with the second embodiment. The program shown in FIG. 15 differs from that of the first embodiment shown in FIG. 7 in that it includes a process 950 including a step of calculating an attention based on general context, in place of the process 494 shown in FIG. 7.

The process 950 is different from the process 494 in that in place of step 508 of process 494, it includes a step 952 of preparing two two-dimensional matrixes, a step 954 branching from step 952, separately from step 510, of calculating the third matrix, and a step 956 of calculating the two fourth matrixes based on the third matrix calculated at step 954 by the same method as shown in FIG. 3; and in that in place of step 514 of FIG. 7, it includes a step 958 of applying to neural network 792 the output of steps 500, 504, 512 and 956.

In the second embodiment, to the first column of neural network 792, an answer received by question receiving unit 50 is applied. To the second column, an answer passage that is being processed is applied. To the third column, all in-passage causality expressions extracted from the answer passage that is being processed, stored in in-passage causality expression storage unit 84, are applied concatenated with a prescribed delimiter. To the fourth column, a causality expression relevant to the answer passage that is being processed, stored in relevant causality expression storage unit 88, is applied.

These are all converted to word-embedding vectors at the input layer 900 of neural network 792. The word embedding vector of each of the words forming the question of the first column and the answer passage of the second column is multiplied by weights obtained from mutual information matrixes \hat{—}A_{q} and \hat{—}Aₚ having weights obtained from the third and fourth matrixes added element by element.

[Results of Experiment]

FIG. 16 shows, in a form of a table, accuracies of answers of a baseline and answers obtained by the system of the first embodiment and the system of the second embodiment, under conditions different from those of FIG. 8 showing the result of the first embodiment.

In FIG. 16, OH13 is the baseline of the experiment, which is the same method as shown in FIG. 8. As can be seen from FIG. 16, as in FIG. 8, the first embodiment shows considerably better performances as compared with the baseline method. The second embodiment, however, attained the significantly higher accuracy as compared with the first embodiment.

In the experiment of which results are shown in FIG. 16, we conducted ten-fold cross validations on 17,000 question-answer pairs (twenty answer candidates to 850 questions) (training: 15,000, development: 1,000, evaluation: 1,000). In FIG. 16, “P@1” indicates the accuracy of the top result, and “MAP” indicates overall quality of top twenty results. The experiment is different from that of FIG. 8 in that ten-fold cross-validation is involved.

As described above, by the first and second embodiments of the present invention, an answer to a non-factoid question can be obtained with the very high accuracy as compared with the conventional methods. By way of example, questions posed on a manufacturing line of a plant, questions raised regarding eventually obtained products, questions posed during software tests, questions posed during some experiments and the like may be used as training data to build question-answering systems, which will provide useful answers to various practical questions. This leads to higher production efficiency in plants, efficient design of industrial products and software, and improved efficiency of experiment plans, significantly contributing to industrial development. Further, application of the invention is not limited to manufacturing business, and it is applicable to the fields of education, service to customers, automatic response at government offices as well as to operation instructions of software.

In the second embodiment, two different attentions, that is, causality attention and similarity attention are used simultaneously. The present invention, however, is not limited to such an embodiment. Depending on an application, different types of attentions may further be used. For example, attentions using the relations below, disclosed in JP2015-121896 A, may be used. Further, in place of one of or both of the causality attention and the similarity attention, attention or attentions of the relations may be used.

material relation (example: <produce B from A> (corn, biofuel)),

necessity relation (example: <A is indispensable for B> (sunlight, photosynthesis)),

use relation (example: <use A for B> (iPS cells, regenerative medicine)) and

prevention relation (example: <prevent B by A> (vaccine, influenza)).

By using such semantic relations, it becomes possible to provide answers with the higher accuracy to questions such as “Why we can use a vaccine against influenza?” “Why are iPS cells attracting attention?” “Why do plants need sunlight?” (respectively corresponding to the prevention relation, use relation and necessity relation).

The attentions of such relations can be obtained in the similar manner as the causality attention. The method described in JP2015-121896 A mentioned above can be used as the method of obtaining expressions representing these relations. Specifically, semantic class information of words and a group of specific patterns (referred to as the seed patterns) which will be the source for extracting semantic relation patterns are stored in database. By extracting patterns similar to these seed patterns stored in the database from web archive storage unit 56, database of semantic relation patterns is built. Expressions matching these semantic patterns are collected from the web archive, and mutual information of words in a set of collected expressions is calculated to generate an attention matrix of the relation. Further, words are similarly extracted from a question and answer passages and, from the attention matrix formed in advance, two matrixes are generated in the similar manner as shown in FIG. 3, to provide weights to the words input to the neural network.

When three or more attentions are used, a classifier similar to classifier 754 shown in FIG. 12 may be prepared for each relation, and the number of columns of neural network 792 may be increased accordingly. Alternatively, only a classifier 754 for a specific semantic relation may be prepared and only the attention or attentions may be calculated for other semantic relations. In that case, a value obtained by adding these attentions element by element may be used as a weight to each word in neural network 792.

### REFERENCES LIST

[Reference 1]

J.-H. Oh, K. Torisawa, C. Hashimoto, R. Iida, M. Tanaka, and J. Kloetzer. A semi-supervised learning approach to why-question answering. In Proceedings of AAAI '16, pages 3022-3029, 2016.

### INDUSTRIAL APPLICABILITY

The present invention is capable of providing answers to various problems encountered in human life. Therefore, it is applicable to an industry manufacturing devices providing such a function, as well as to an industry providing people with such a function over a network. Further, the present invention is capable of providing responses such as a cause, a method, a definition or the like to various problems encountered by a subject in industrial and research activities regardless of their fields. Therefore, use of the present invention enables smoother and speedier industrial activities and research activities in every field of industry and every field of research.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

30, 730 non-factoid question-answering system
32, 130 question
34 question-answering system
36 answer
40 causality attention processing unit
50 question receiving unit
52 answer receiving unit
54, 754 classifier
56 web archive storage unit
58, 82 causality expression extracting unit
60 archive causality expression storage unit
62 mutual information calculating unit
64 mutual information matrix storage unit
66 answer candidate storage unit
68 answer candidate ranking unit
80 answer passage storage unit
84 in-passage causality expression storage unit
86 relevant causality expression extracting unit
88 relevant causality expression storage unit
90 causality attention matrix generating unit
92, 792 neural network
110 question-related archive causality expression selecting unit
112 question-related causality expression storage unit
114 ranking unit
120, 820 word extracting unit
122 first matrix calculating unit
124 second matrix calculating unit
150 noun extracting unit
152 verb/adjective extracting unit
154 first retrieving unit
156 second retrieving unit
170 first mutual information matrix A
180, 182 matrix
200, 900 input layer
202, 902 convolution/pooling layer
204, 904 output layer
208 word matching
216, 916 Softmax layer
740 similarity attention processing unit
758 semantic vector calculating unit
762 similarity calculating unit
764 similarity matrix storage unit
790 similarity attention matrix generating unit
822 third matrix calculating unit
824 fourth matrix calculating unit

1. A non-factoid question-answering system generating an answer to a non-factoid question by focusing on an expression representing a first semantic relation appearing in text, comprising:
a first expression storage means for storing a plurality of expressions representing said first semantic relation;
a question/answer receiving means for receiving a question and a plurality of answer passages including an answer candidate to the question;
a first expression extracting means for extracting a semantic relation expression representing said first semantic relation from each of the plurality of answer passages;
a relevant expression selecting means for selecting, for each of the combinations of said question and said plurality of answer passages, a relevant expression that is an expression most relevant to said combination, from said plurality of expressions stored in said first expression storage means; and
an answer selecting means trained in advance by machine learning to receive, as inputs, each combination of said question, said plurality of answer passages, said semantic relation expressions for the answer passages, and one of said relevant expressions for a combination of said question and the answer passages, and to select an answer to said question from said plurality of answer passages.

2. The non-factoid question-answering system according to claim 1, further comprising:
a first semantic correlation calculating means for calculating, for each combination of said question and said plurality of answer passages, a first semantic correlation between each of the words appearing in said question and each of the words appearing in the answer passage in said plurality of expressions stored in said first expression storage means; wherein
said answer selecting means includes
an evaluating means trained in advance by machine learning to receive, as inputs, a combination of said question, said plurality of answer passages, said semantic relation expressions for the answer passages, and said relevant expressions for a combination of said question and the answer passages, and to calculate and output an evaluation value representing a measure that said answer passage is an answer to said question, using said first semantic correlation as a weight to each word in the inputs; and
a selecting means for selecting one of said plurality of answer passages as an answer to said question, using said evaluation value output by said evaluating means for each of said plurality of answer passages.

3. The non-factoid question-answering system according to claim 1, further comprising a first semantic relation expression extracting means for extracting an expression representing said first semantic relation from a document archive and for storing it in said first expression storage means.

4. The non-factoid question-answering system according to claim 2, wherein
said first semantic correlation calculating means includes:
a first semantic correlation storage means for calculating and storing said first semantic correlation of a word pair included in a plurality of expressions representing said first semantic relation stored in said first expression storage means, for each word pair;
a first matrix generating means for reading, for each combination of said question and said plurality of answer passages, said first semantic correlation of each pair of words in said question and words in the answer passage, from said first semantic correlation storage means, for generating a first matrix having words in said question arranged along one axis and words in the answer passage arranged along the other axis, and having, arranged in each cell at an intersection of said one and the other axes, said first semantic correlation between words at corresponding positions; and
a second matrix generating means for generating two second matrixes, comprised of a first word-sentence matrix for storing, for each of the words arranged along said one axis of said first matrix, the maximum value of said first semantic correlations arranged along said the other axis, and a second word-sentence matrix for storing, for each of the words arranged along said the other axis of said first matrix, the maximum value of said first semantic correlations arranged along said one axis;
said non-factoid question-answering system further comprising
a means for adding a weight to each of the words appearing in said question applied to said answer selecting means using said first semantic correlation of said first word-sentence matrix, and for adding a weight to each of the words appearing in said answer passage using said first semantic correlation of said second word-sentence matrix.

5. The non-factoid question-answering system according to claim 4, wherein each of said first semantic correlations stored in said two second matrixes is normalized in a prescribed range.

6. The non-factoid question-answering system according to claim 1, wherein said first semantic relation is causality.

7. The non-factoid question-answering system according to claim 6, wherein
each of said expressions representing said causality includes a cause part and an effect part; and
said relevant expression selecting means includes:
a first word extracting means for extracting a noun, a verb and an adjective from said question;
a first expression selecting means for selecting, from the expressions stored in said first expression storage means, only a prescribed number of expressions that includes all the nouns extracted by said first word extracting means in said effect part;
a second expression selecting means for selecting, from the expressions stored in said first expression storage means, only a prescribed number of expressions that include all the nouns extracted by said first word extracting means and include at least one of the verbs or adjectives extracted by said first word extracting means in said effect part; and
a causality expression selecting means for selecting, for each of said plurality of answer passages, from the expressions selected by said first and second expression selecting means, one that has in said effect part a word common to the answer passage and that is determined to have the highest relevance to the answer passage in accordance with a score calculated by the weight to the common word.

8. The non-factoid question-answering system according to claim 2, generating an answer to a non-factoid question by focusing on an expression representing said first semantic relation and an expression representing a second semantic relation appearing in text, said system further comprising:
a second expression storage means for storing a plurality of expressions representing said second semantic relation; and
a second semantic correlation calculating means for calculating, for a combination of said question and each of said plurality of answer passages, a second semantic correlation representing correlation between each of the words appearing in said question and each of the words appearing in the answer passage in said plurality of expressions stored in said second expression storage means; wherein
said evaluating means includes a neural network trained in advance by machine learning to receive, as inputs, a combination of said question, said plurality of answer passages, said semantic relation expressions for the answer passages extracted by said first expression extracting means, and said relevant expressions for said question and the answer passages, and to calculate and output said evaluation value, using said first semantic correlation and said second semantic correlation as a weight to each word in the inputs.

9. The non-factoid question-answering system according to claim 8, wherein
said second semantic relation is a common semantic relation not limited to a specific semantic relation; and
said second expression storage means stores expressions collected at random.

10. A computer program stored on a non-transitory computer readable medium which, when executed, causes a computer to function as each of the means described in claim 1.

11. A method of answering to a non-factoid question, realized by a computer generating an answer to a non-factoid question by focusing on an expression representing a prescribed first semantic relation appearing in text, comprising the steps of:
said computer connecting to and enabling communication with a first storage device for storing a plurality of expressions representing said first semantic relation;
said computer receiving, through an input device, a question and a plurality of answer passages each including an answer candidate to the question;
said computer extracting, from said plurality of answer passages, an expression representing said first semantic relation;
said computer selecting, for each combination of said question and said plurality of answer passages, an expression most relevant to the combination, from said plurality of expressions stored in said first expression storage means; and
said computer inputting each of combinations of said question, said plurality of answer passages, the plurality of expressions extracted at said step of extracting, and one of the expressions selected at said step of selecting, to an answer selecting means that is trained in advance by machine learning to select an answer to said question from said plurality of answer passages, and obtaining its output, and thereby generating an answer to said question.

12. The method of answering to a non-factoid question according to claim 11, further comprising the step of:
said computer calculating, for each combination of said question and said plurality of answer passages, a first semantic correlation representing correlation between each of the words appearing in said question and each of the words appearing in the answer passage in said plurality of expressions stored in said first expression storage means; wherein
said selecting step includes the step of said computer applying each of combinations of said question, said plurality of answer passages, said expression extracted at said step of extracting from the answer passage, and said expression selected at said selecting step for said question and the answer passage, as an input to an evaluating means trained in advance by machine learning to calculate and output an evaluation value representing a measure that said answer passage is an answer to said question; and
said evaluating means uses said first semantic correlation as a weight to each word in said input in calculating said evaluation value;
said method further comprising the step of said computer selecting one of said plurality of answer passages as an answer to said question, using said evaluation value output by said evaluating means to each of said plurality of answer passages.
